(19) United States
(12) Patent Application Publication
(10) Pub. No.: US 2003/0205576 A1
(43) Pub. Date: Nov. 6, 2003

(54) Cylindrical reactor with an extended focal region

(76) Inventors: J Michael Drozd, Raleigh, NC (US); William T. Joines, Durham, NC (US)

Correspondence Address: BURNS DOANE SWECKER & MATHIS L L P, POST OFFICE BOX 1404, ALEXANDRIA, VA, 22313-1404, US

(21) Appl. No.: 10/149,015

(22) PCT Filed: Dec. 7, 2000
(86) PCT No.: PCT/US00/33080

(51) Int. Cl. H05B 6/74

(52) U.S. Cl. 219/746; 219/745

(57) ABSTRACT

An elliptical exposure chamber has an extended focal region. A plurality of cylindrical reactors (25) form the extended focal region. Reducing the size of the opening (58) to each reactor (25) reduces the amount of energy reflected and increases the overall heating. In order to efficiently deliver the electromagnetic energy to the reduced opening (58), a tapered waveguide (55) has a concave end (56). A power splitter (42) divides power from a central waveguide (52) to the plurality of reactors (25). The power that is delivered to each reactor (25) can be adjusted by adjusting the impedance of each reactor (25), the width of each reactor (25) or the width of the opening (58) to each reactor (25). The width of the opening (58) to each reactor (25) can be controlled by a movable metal plate (44). A dielectric wheel can be used to shift hot spots along the focal region.

### FIELD OF INVENTION

This invention relates to electromagnetic energy, and more particularly, to providing more efficient electromagnetic exposure.

### BACKGROUND

U.S. Pat. No. 5,998,774, which is incorporated by reference in its entirety, describes an invention for creating uniformity over a cylindrical region, herein referred to as the standard cylindrical reactor. Unfortunately, the exposure width of this invention for maintaining true uniformity is limited by the maximum waveguide width for keeping the electromagnetic wave in TE₁₀ mode. Limited width has a disadvantage in exposing materials that require a longer exposure time to microwave energy. Similarly, some materials are not able to withstand a high power density, and a wider exposure region would lead to a lower power density.

### SUMMARY

An elliptical exposure chamber has an extended focal region. In an exemplary embodiment, a plurality of cylindrical reactors form the extended focal region. Reducing the size of the opening to each cylindrical reactor reduces the amount of energy reflected and increases the overall heating. In order to efficiently deliver the electromagnetic energy to the reduced opening, a tapered waveguide has a concave end. A power splitter divides power from a central waveguide to the plurality of cylindrical reactors. The power that is delivered to each cylindrical reactor can be adjusted by adjusting the impedance of each reactor (i.e. increasing or decreasing the impedance matching), adjusting the width of each reactor, or adjusting the width of the opening to each reactor. The width of the opening to each reactor can be controlled by, for example, a movable metal plate. A dielectric wheel can be used to shift hot spots along the focal region.

### BRIEF DESCRIPTION OF THE DRAWINGS

The foregoing, and other objects, features, and advantages of the invention will be more readily understood upon reading the following detailed description in conjunction with the drawings in which:

FIG. 1 illustrates a cascaded cylindrical reactor;

FIGS. 2 and 3 illustrate field intensity in a cascaded cylindrical reactor;

FIG. 4 illustrates field intensity across the focal region;

FIG. 5 illustrates an improved cascaded cylindrical reactor;

FIG. 6 illustrates an extended cylindrical reactor; and

FIGS. 7 and 8 illustrate field distribution in an extended cylindrical reactor.

### DETAILED DESCRIPTION

In the following description, specific details are discussed in order to provide a better understanding of the invention. However, it will be apparent to those skilled in the art that the invention can be practiced in other embodiments that depart from these specific details. In other instances, detailed descriptions of well-known methods and circuits are omitted so as to not obscure the description of the invention with unnecessary detail.

The present invention extends the useful width of the cylindrical reactor to virtually any width. There are two basic embodiments of the invention. The first embodiment cascades multiple cylindrical reactors together, herein referred to as the cascaded cylindrical reactor. The second embodiment simply widens the exposure region for a standard cylindrical reactor, herein referred to as the extended cylindrical reactor.

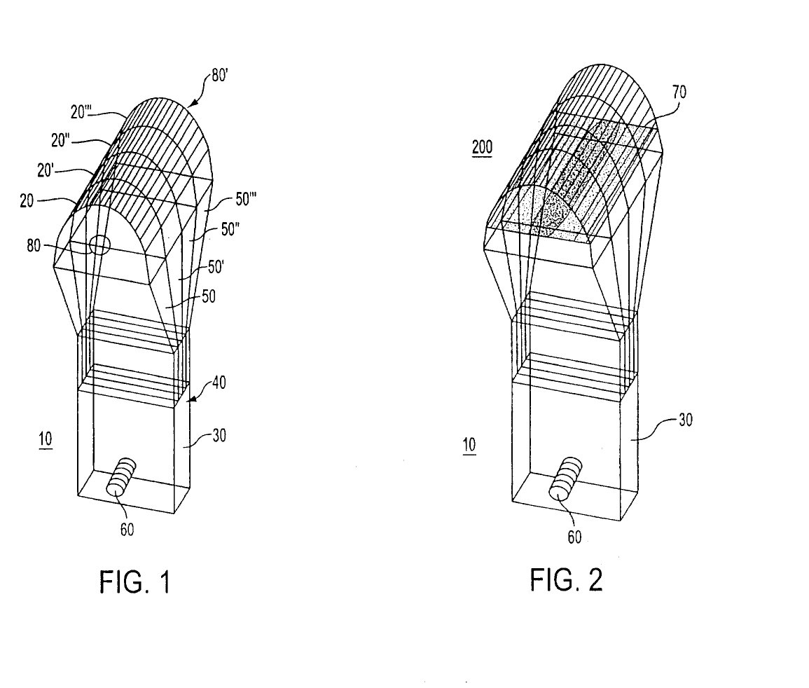

FIG. 1 illustrates a cascaded cylindrical reactor. In the cascaded cylindrical reactor 10, the series of cylindrical reactors 20 are in direct contact or in close proximity. Power into the series of cylindrical reactors can be provided by a single waveguide 30. Using a power splitter 40, energy can be split into multiple waveguides 50 and then into each individual cylindrical reactor 20. The power splitter 40 could be as simple as placing septums into the single waveguide 30 parallel to the broad wall of waveguide 30. Using these power splitters 40 may require impedance matching 60 to insure maximum transfer of power to each individual reactor 20.

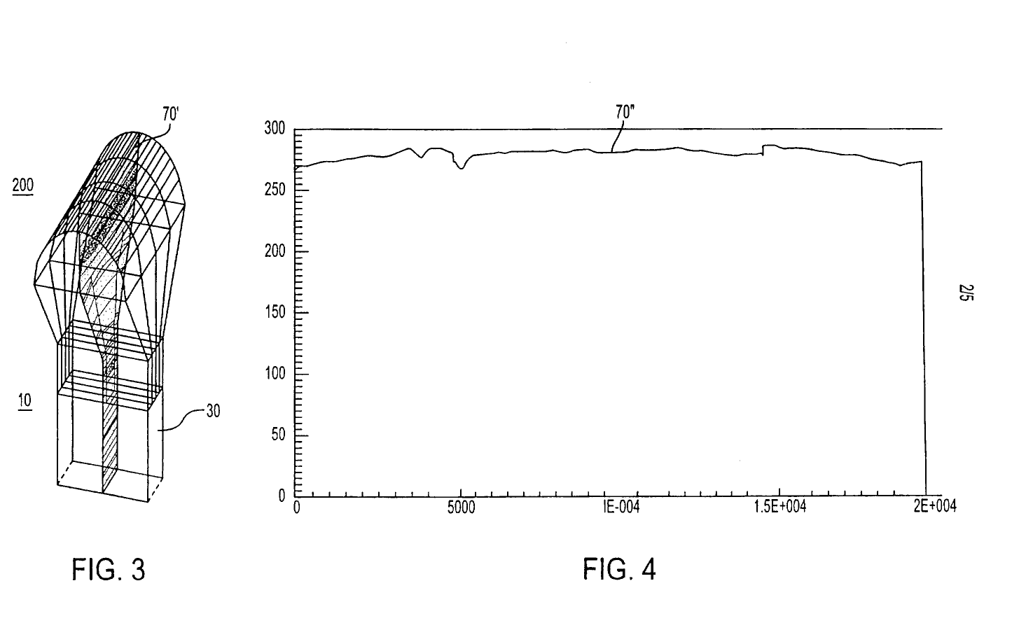

FIGS. 2 and 3 illustrate the field distribution 70 in chamber 200. It is important to note the degree of uniformity over a wide width. FIG. 4 is the field intensity 70′ across the focal region of chamber 200.

With the cascaded cylindrical reactor 10, it is possible to create a system in which each individual cylindrical reactor 20 has a different field intensity. Varying the field intensity between each individual cylindrical reactor 20 allows a material to be exposed to different levels of microwave energy 70 as it passes through the system, and more specifically, opening 80. This can be accomplished in a number of ways. First, a tuning stub 60 can be placed in each individual septum. These tuning stubs 60 affect the impedance of each individual reactor 20 and thus the amount of energy that propagates in each cylindrical reactor 20. Another way of affecting the amount of microwave energy in each cavity 20 is by changing the distances between each septum in the power splitter. One advantage of changing the field intensity between each cylindrical reactor 20 is that a predefined temperature distribution over time can be achieved throughout the process. For example, it may be desirable to initially have a slow ramp in temperature and end with a very high ramp in temperature.

As a final note on the cascaded cylindrical reactor 10, there is practical limit on splitting a single waveguide 30. To extend the width beyond this limit, each septum of the first waveguide can be formed into a waveguide that can then be split into more waveguides. This may require impedance matching 60 at each power splitter.

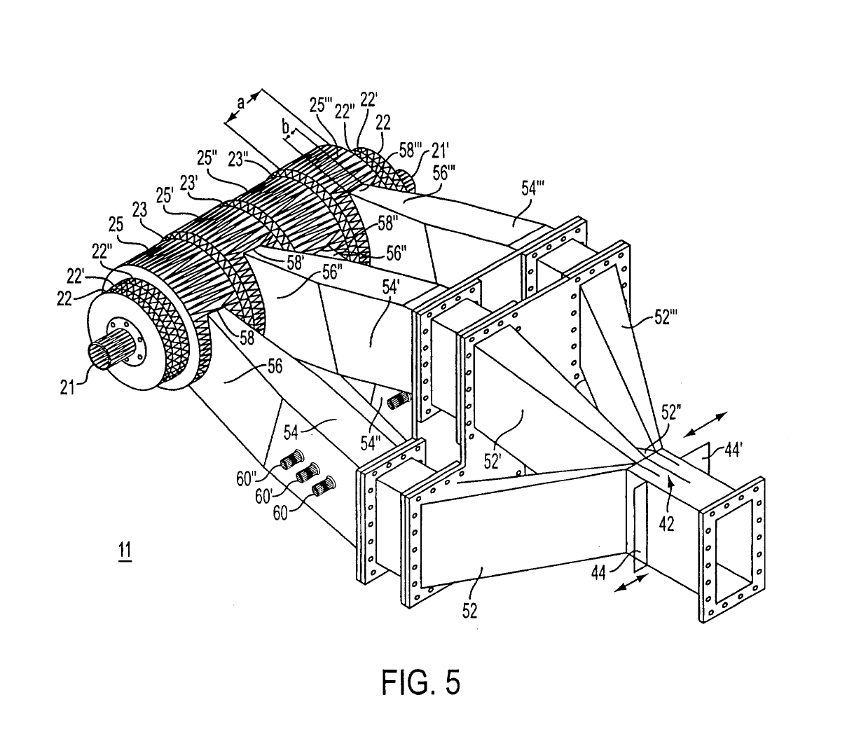

FIG. 5 illustrates an improved cascaded cylindrical reactor 11. In the improved reactor 11, the cylindrical reactors 25 are preferably separated by choke flanges 23. The spacing of the cylindrical reactors 25 (i.e. the width of choke flange 23) can be increased or decreased to control the amount of cooling between each reactor 25. Using a power splitter 42, energy can be split into multiple secondary waveguides 52. Or alternatively, each waveguide 52 can be powered by a separate source. The power delivered to each reactor 25 can be controlled by a movable metal plate 44 and/or increasing or decreasing the impedance matching 60. It will be appreciated by those skilled in the art that as a solid melts the dielectric values change. As a solid, the material may absorb less energy. As a liquid, the material may absorb more energy. Accordingly, it may be advantageous to increase power to initial reactor 25 and decrease power to subsequent reactors 25′.

According to the improved design, the multiple waveguides 52 are spaced so that each waveguide 52 is easily accessible. This can be achieved by projecting waveguide 52′ upwardly and an adjacent waveguide 52″ downwardly. In addition, each cylindrical reactor 25 comprises a circular shape that has a reduced opening 58. If, for example, reactor 25 has a width of a, opening 58 has a width of b, where b is less than a. Reducing the size of opening 58 reduces the amount of energy reflected and increases the overall heating. In order to efficiently deliver the electromagnetic energy to reduced opening 58, tertiary waveguide 54 is connected to a tapered region 55. Tapered region 55 comprises a concave end 56, where concave end 56 engages a convex exterior surface of reactor 25. Electromagnetic energy is contained within reactor 25 by three circular choke flanges 22 and an outwardly extending choke 21. The distance between the outside edge of choke flange 22 and the outside edge of choke 21 is equal to a quarter of a wave length of the electromagnetic wave in reactor 25.

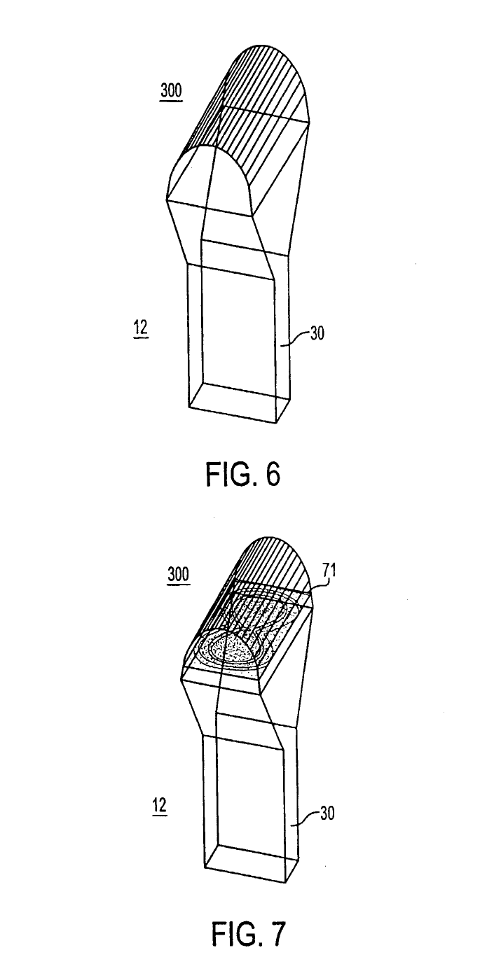

FIG. 6 illustrates an extended cylindrical reactor 12. The extended cylindrical reactor design 12 is similar to the standard cylindrical reactor 10 except that the exposure width 300 has been extended. The height of the exposure region 300 is not altered nor is the distance to the focal region.

The effect of simply widening the exposure region 300 is that modes beyond TE₁₀ are generated. However, if the height is not changed from the standard cylindrical reactor, then the only modes that are created are across the exposure width. As a result, a cylindrical field pattern 71 is maintained at every cross section, but hot and cold spots appear along the exposure region.

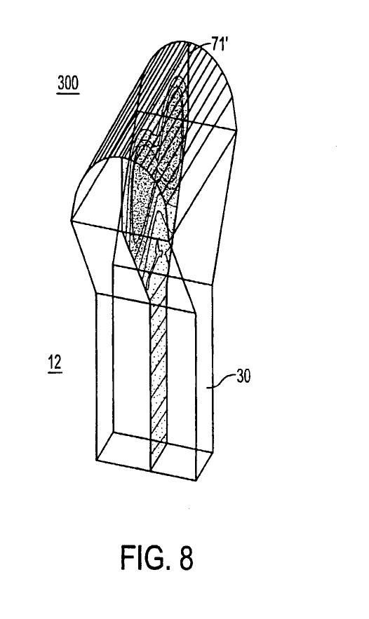

FIGS. 7 and 8 illustrate the field pattern 71 in an extended cylindrical reactor 12. For some applications, hot spots are not tolerable. However, for most continuous flow applications, systematic hot spots would not present a problem. In fact in some instances exposing some materials to alternating hot and cold spots may have advantages. It should also be noted that it is possible to cause the hot spot pattern to dynamically shift. One way to accomplish this would be to introduce a rotating dielectric. This would continually change the effective width of the exposure width and thus dynamically shift the hot spots. The net result would be a more uniform exposure of the material.

While the foregoing description makes reference to particular illustrative embodiments, these examples should not be construed as limitations. Thus, the present invention is not limited to the disclosed embodiments, but is to be accorded the widest scope consistent with the claims below.

What is claimed is:

1. An elliptical exposure chamber comprising an extended focal region.

2. A device as described in claim 1, the device further comprising a plurality of cylindrical reactors, the plurality of cylindrical reactors forming the extended focal region.

3. A device as described in claim 2, the device comprising a power splitter, the power splitter dividing power from a central waveguide to the plurality of cylindrical reactors.

4. A device as described in claim 3, the device further comprising a second power splitter, the second power splitter dividing power from a second central waveguide to the first central waveguide.

5. A device as described in claim 2, the device further comprising septums parallel to a broad wall of a central waveguide, the septums dividing power from the central waveguide to the plurality of cylindrical reactors.

6. A device as described in claim 3, the device further comprising a tuning stub for matching the impedance of the power splitter.

7. A device as described in claim 6, wherein an impedance is adjusted to vary an amount of energy delivered to a cylindrical reactor.

8. A device as described in claim 5, wherein a septum width is adjusted to vary an amount of energy delivered to a cylindrical reactor.

9. A device as described in claim 2, a movable metal plate controlling the amount of power delivered to at least one of the cylindrical reactors.

10. A device as described in claim 1, wherein a dielectric wheel shifts hot spots along the extended focal region.

11. A device as described in claim 3, the power splitter connected to a plurality of secondary waveguides, a first secondary waveguide projecting upwardly, a second secondary waveguide projecting downwardly.

12. A device as described in claim 2, wherein two cylindrical reactors are separated by a choke flange.

13. An exposure chamber comprising a cylinder region with a width equal to a and an electromagnetic waveguide connected to the cylinder region, the electromagnetic waveguide forming an opening to the cylinder region, the width of the opening equal to b, where b is less than a.

14. A device as described in claim 12, wherein the electromagnetic waveguide is a tapered waveguide.

15. A device as described in claim 13, the electromagnetic waveguide comprising a concave end.

16. A device as described in claim 15, wherein the electromagnetic waveguide is a tapered waveguide.
